(19) United States
(12) Patent Application Publication
(10) Pub. No.: US 2025/0321871 A1
(43) Pub. Date: Oct. 16, 2025

(54) Determining Application Test Results Using Adaptive Objects

(71) Applicant: eBay Inc., San Jose, CA (US)

(72) Inventor: Shawn Zhang, St. Catharines (CA)

(73) Assignee: eBay Inc., San Jose, CA (US)

(21) Appl. No.: 19/000,572

(22) Filed: Dec. 23, 2024

Related U.S. Application Data
(60) Provisional application No. 63/633,498, filed on Apr. 12, 2024.

(51) Int. Cl. G06F 11/3668

(52) U.S. Cl. CPC G06F 11/3688

(57) ABSTRACT

A test-oriented architectural framework for determining application test results using adaptive objects is described. A data structure for data communications associated with a system-under-test (SUT) is generated for the test-oriented architectural framework. In a test framework associated with the SUT, services that communicate with the SUT using objects are identified. Each object includes at least one field and data items that correspond to the fields. An object is communicated between the SUT and the service associated with the SUT. Based on this object, the test framework generates a structure that maps the set of fields in the object to the data types of the data items therein. Additional objects communicated between the SUT and the service are then automatically regression tested using the structure.

### CROSS-REFERENCE TO RELATED APPLICATION

This application claims priority to U.S. Provisional Patent Application No. 63/633,498, filed Apr. 12, 2024, and entitled “Test-Oriented Architectural Framework,” the content of which is incorporated herein by reference in its entirety.

### BACKGROUND

Companies that transition to a microservices architecture and agile development processes are able to release new product features and improvements quickly and often. These improvements are rolled out using small-sized product releases and end-to-end release pipelines. However, conventional techniques for writing and updating tests to align these tests with the updated results associated with new code changes remains laborious and time-consuming.

### SUMMARY

A process for determining application test results using adaptive objects and generating data structures for data communications associated with a system-under-test (SUT) is described. In one or more implementations, services designed to communicate with the SUT using multiple objects are identified at a test framework associated with the SUT. Each object includes one or more fields and data items that correspond to the fields. An object communicated between the SUT and a service associated with the SUT is then obtained. Based on the obtained object, a structure that documents a set of fields and data types of data items mapped to the set of fields is generated. Additional objects communicated between the SUT and the service are then automatically regression tested based on the generated structure.

This Summary introduces a simplified selection of concepts described below in the Detailed Description. As such, this Summary is not intended to identify essential features of the claimed subject matter or to aid in determining its scope.

### BRIEF DESCRIPTION OF THE DRAWINGS

The detailed description is described with reference to the accompanying figures.

FIG. 1 is an illustration of an environment in an example implementation that is operable to employ techniques for a test-oriented architectural framework for determining application test results using adaptive objects as described herein.

FIG. 2 depicts an example procedure for converting a data object to a data structure in a test-oriented architectural framework for determining application test results using adaptive objects to employ techniques described herein.

FIG. 3 illustrates an example procedure for a cache flow of a mock proxy system to employ techniques described herein.

FIG. 4 illustrates an example procedure for a recording flow of a mock proxy system to employ techniques described herein.

FIG. 5 illustrates an example procedure for a forwarding and recording flow of the mock proxy system to employ techniques described herein.

FIG. 6 illustrates an example procedure for verifying an upstream and downstream contract to employ techniques described herein.

FIG. 7 illustrates an example implementation of a mock server used in a test-oriented architectural framework for determining application test results using adaptive objects to employ techniques described herein.

FIG. 8 illustrates an example procedure to implement a test-oriented architectural framework for determining application test results using adaptive objects.

FIG. 9 illustrates an example of a system that includes an example computing device that is representative of one or more computing systems and/or devices that may implement services tested using a test-oriented architectural framework for determining application test results using adaptive objects and the various techniques described herein.

### DETAILED DESCRIPTION

### Overview

In today's rapidly changing online world, software companies must act quickly to meet the demands of their customers. To achieve this, the software industry has adopted continuous delivery as a major strategy, resulting in shorter software development life cycles. However, this trend presents a challenge to increase the speed of product delivery while ensuring software quality. In response, test automation has become a crucial part of software deployment.

In recent years, the availability of tools, frameworks, and cloud services for automated testing has grown. However, developing effective automated testing that aligns with rapid delivery goals, ensures high product quality, and integrates well with the development team is challenging. Creating tests often demands a deep understanding of product requirements, software architectures, and comprehensive knowledge and experience with test automation frameworks, tools, and products for test automation, which can be overwhelming.

Microservices present organizations with new testing challenges. Downstream services often depend on external systems (e.g., databases, servers, and other upstream services requiring coordination with external teams) and involve multiple data sources, a large volume of requests, and complex data transformations, making testing difficult and time-consuming. Microservices are also vulnerable to security threats (e.g., unauthorized access, data breaches, and denial-of-service attacks). As a result, it is crucial to ensure the security of downstream services and protect sensitive data. Authentication issues can also prevent downstream services from obtaining the correct data. Compatibility issues and failures can occur with changes to upstream services. Lastly, downstream services may require specific testing environments that can be time-consuming.

This document presents a test-oriented architectural framework for determining application test results using adaptive objects that aims to overcome these challenges in software testing. The framework includes a snapshot testing method that employs a specific data format to facilitate updating mock data from upstream services and test results from downstream services. The systems and techniques described herein result in faster and more efficient testing. Additionally, the framework offers reusable services, libraries, template projects, and continuous integration and delivery (CI/CD) pipeline scripts to streamline testing and allow developers to focus efforts on software improvements.

The test-oriented architectural framework for determining application test results using adaptive objects discussed in this document differs from test-driven development in that it is more flexible and comprehensive. Testing is considered an integral part of the software architecture design process in the test-oriented architecture, and testing solutions are identified right at the beginning. The approach does not involve writing test code before starting development. Instead, test solutions and plans are developed beforehand and then refined and updated as needed to accommodate a microservice architecture's agility better.

The test-oriented architectural framework for determining application test results using adaptive objects also uses a mock proxy system with a specific application programming interface (API) request control method. The mock proxy system leverages the parameters passed through the test request headers and combines them with the proxy identification (e.g., captured from the modified upstream request URL path sent to the mock proxy system) to determine whether a production data recording or mock data return is needed. In addition, because a relatively low number of requests are handled, the described mock proxy system combines the speed of an in-memory cache with the flexibility and low cost of cloud storage. The API request control method also allows the test scope to be changed on the fly and enables different testing tasks to be performed from a local test environment or the CI/CD pipeline.

In accordance with the described techniques, a test-oriented architecture framework for determining application test results using adaptive objects uses specialized data structures to improve and quicken microservices testing. In one or more implementations, data structures for data communications associated with a system-under-test (SUT) are generated. Using a test framework associated with the SUT, services that communicate with the SUT are identified using objects, which include at least one field and data items corresponding to each field. For example, the objects are adaptive JavaScript Object Notation (JSON) objects. An object communicated between the SUT and a service associated therewith is obtained. Based on this object, a structure (e.g., a JSON Contract) is generated that documents a set of fields and data types of data items mapped to the set of fields for the object. The structure, for example, has a JSON format. Additional objects communicated between the SUT and the service are then regression-tested based on the generated structure. In this way, the SUT is tested more efficiently and timely.

In some aspects, the techniques described herein relate to a method for generating data structures for data communications associated with a SUT, the method comprising identifying, at a test framework associated with the SUT, one or more upstream services configured to communicate with the SUT using a plurality of objects, wherein each object of the plurality of objects includes one or more fields and one or more data items corresponding to the one or more fields, obtaining an object communicated between the SUT and an upstream service of the one or more upstream services, generating, based on the object, a data structure that documents a set of fields and data types of data items mapped to the set of fields in the object, and performing regression testing, using the data structure, on additional objects communicated between the SUT and the upstream service.

In some aspects, the techniques described herein relate to a method wherein the plurality of objects and the object are JSON objects and the data structure is configured to have a JSON format.

In some aspects, the techniques described herein relate to a method wherein the data structure with the JSON format is automatically generated from the JSON object communicated between the SUT and the upstream service associated with the SUT.

In some aspects, the techniques described herein relate to a method wherein generating the data structure based on the object comprises iterating over each node of the object, in response to the node being an object, iterating over each subnode of the node, in response to the node or the subnode being an array without the compact-style output, iterating over each array element of the array, and replacing the node, the subnode, or the array element with a string indicator of its type.

In some aspects, the techniques described herein relate to a method wherein generating the data structure based on the object further comprises generating a partial data structure having the JSON format and a subset of the set of fields.

In some aspects, the techniques described herein related to a method wherein the data structure is generated for the set of fields that match instructions in a converter object.

In some aspects, the techniques described herein related to a method wherein the converter object includes a main filter object that includes an inclusive filter list and an exclusive filter list and a structure filter object that includes a convert filter list and a keep filter list.

In some aspects, the techniques described herein related to a method wherein applying the converter object to the object comprises converting the object to the data structure using the structure filter object and retrieving data in the data structure using the main filter object.

In some aspects, the techniques described herein related to a method wherein applying the structure filter object to the object comprises finding each valid convert path of one or more valid convert paths using the convert filter list, for each valid convert path, finding each keep object of one or more keep objects based on the keep filter list, converting the data items to structure data based on the one or more valid convert paths; and restoring the structure data from the one or more keep objects.

In some aspects, the techniques described herein relate to a method wherein applying the main filter object comprises removing the structure data that matches exclusive filters in the exclusive filter list and creating the structure data based on inclusive filters in the inclusive filter list.

In some aspects, the systems described herein relate to a system comprising one or more processors associated with a test framework, the one or more processors configured to: identify one or more upstream services configured to communicate with a SUT using a plurality of objects, wherein each object of the plurality of objects includes one or more fields and one or more data items corresponding to the one or more fields, obtain an object communicated between the SUT and an upstream service of the one or more upstream services, generate, based on the object, a data structure that documents a set of fields and data types of data items mapped to the set of fields in the object, and perform regression testing, using the data structure, on additional objects communicated between the SUT and the upstream service.

In some aspects, the systems described herein relate to a system wherein the additional objects are generated based on mock data stored by a mock proxy system, the mock data being a saved upstream response of the upstream service to an upstream request.

In some aspects, the systems described herein relate to a system wherein the mock data is stored in cloud storage.

In some aspects, the systems described herein relate to a system wherein the mock proxy system determines whether to save an upstream response based on parameters passed in test request headers and an identification associated with the SUT.

In some aspects, the systems described herein relate to a system wherein the system includes another SUT configured to receive a service request from the SUT via the mock proxy system, send the upstream request to the mock proxy system, receive the upstream response as the mock data from the mock proxy system, and send a return service request to the SUT via the mock proxy system, the return service request including the additional objects.

In some aspects, the systems described herein relate to a system wherein the system includes another SUT configured to receive a service request from the SUT via a first mock proxy system, send the upstream request to a second mock proxy system, receive the upstream response as the mock data from the second mock proxy system, and send a return service request to the SUT via the first mock proxy system, the return service request including the additional objects.

In some aspects, the systems described herein relate to a system wherein the plurality of objects and the object are JSO) objects and the data structure is configured to have a JSON format, and the data structure with the JSON format is automatically generated from the JSON object communicated between the SUT and the upstream service associated with the SUT.

In some aspects, the systems described herein relate to a system wherein the one or more processors are further configured to generate the data structure based on the object by iterating over each node of the object, in response to the node being an object, iterating over each subnode of the node, in response to the node or the subnode being an array with a compact-style output, keeping a first item of the array, in response to the node or the subnode being an array without the compact-style output, iterating over each array element of the array; and replacing the node, the subnode, or the array element with a string indicator of its type.

In some aspects, the systems described herein relate to computer-readable storage media comprising computer-executable instructions stored thereon that, responsive to execution by one or more processors, perform operations comprising identifying one or more services configured to communicate with a SUT using a plurality of objects, wherein each object of the plurality of objects includes one or more fields and one or more data items corresponding to the one or more fields, obtaining an object communicated between the SUT and a service of the one or more services, generating, based on the object, a data structure that documents a set of fields and data types of data items mapped to the set of fields in the object, and automatically perform regression testing, using the data structure, on additional objects communicated between the SUT and the service.

In some aspects, the systems described herein relate to computer-readable storage media wherein the plurality of objects and the object are JSON objects and the data structure is configured to have a JSON format, and the data structure with the JSON format is automatically generated from the JSON object communicated between the SUT and the service associated with the SUT.

In the following discussion, an exemplary environment that may employ the techniques described herein is first described. Then, examples of implementation details and procedures are described that may be performed in the exemplary environment as well as other environments. Performance of the exemplary procedures is not limited to the exemplary environment, and performance of the exemplary procedures is not limited to the exemplary environment.

### Example of an Environment

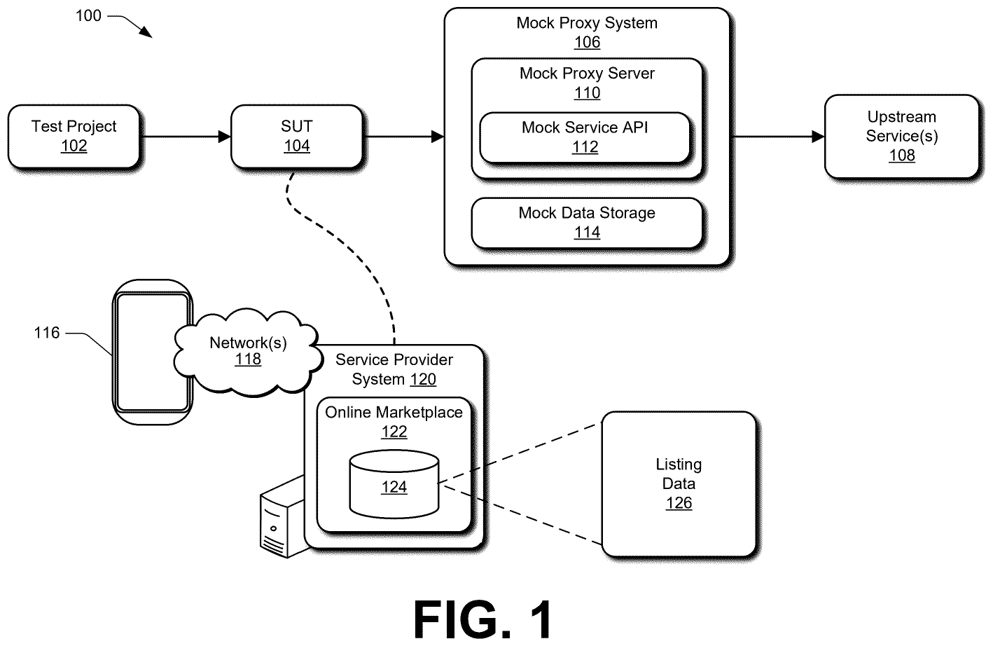

FIG. 1 illustrates an environment 100 in an example implementation that is operable to employ techniques for a test-oriented architectural framework for determining application test results using adaptive objects. The environment 100 includes a test project 102, a system under test (SUT) 104, a mock proxy system 106, and one or more upstream services 108. The mock proxy system 106 includes a mock proxy server 110 that runs a mock service API 112 and mock data storage 114. The illustrated test-oriented architectural framework collectively allows engineers to run tests regularly, in a local environment at the development stage, and/or continuously in a CI pipeline anytime during the development process.

The test project 102 utilizes a form of snapshot testing to provide an efficient approach to write tests and perform regression testing. In some implementations, the snapshot testing is referred to as JSON snapshot testing. Snapshot testing is a form of output comparison or golden-master testing, which prevents regressions by comparing the current characteristics of an application or component with stored “good” values for the same application or component, respectively. While unit or functional tests make assertions about the correct behavior of a service, snapshot tests assert that the type of output now is the same as before.

Snapshot tests generally include two steps. First, a request is sent to the SUT 104 or an API associated with the SUT 104. Once a response (e.g., a JSON response) is received, it is saved as a base snapshot file. Second, subsequent tests call the SUT 104 or the SUT API and compare the response (e.g., a current or new JSON response) with the base snapshot file. If the responses match, the SUT 104 passes. If they do not match, a bug has been found in the SUT 104 that should be fixed. In some scenarios, the lack of a match indicates that an implementation or overall system has changed, and a new base snapshot file should be recorded.

Snapshot tests within the described test-oriented architectural framework are structured using a specific directory/file name convention. For example, the test class reads the test data from the testPath and testFilename. If no testFilename is provided, the test class reads each file (e.g., JSON files) from the testPath folder. In other implementations, the test project 102 may use testing methods and structures compatible with TestNG, Breeze, or other test frameworks.

The test project 102 includes test cases, test data, baseline snapshots, and test reports. The test project 102 is implementable in different languages, including based on Java and TestNG. In addition, the test project 102 supports several ways to organize test cases, including the following scenarios: regular TestNG code with Java test files; regular TestNG code with JSONPath and Java test files to leverage JSONPath to retrieve specific values from the JSON response; Java test files with one JSON input file and one or more test cases inside; and Java test files with multiple JSON input files. Software engineers can manually check the matches or differences in the snapshot test results. The test project 102 can also send requests to a mock proxy server 110 of the mock proxy system 106 to prepare or update testing settings of the mock proxy server 110.

In other implementations, test project 102 uses machine-learning models or other deep-learning solutions to evaluate the test results, identify the regression differences (if any), and summarize them. For example, a transformer machine-learning model based on an attention mechanism can automatically classify the test results. In another implementation, generative pre-trained transformers (GPT) are used to automatically summarize the test results.

The SUT 104, which may also be interchangeably called an application under test (AUT) or service under test, refers to a system, application, service, or groups thereof validated within the test-oriented architectural framework. The upstream services 108 (e.g., upstream microservices) provide data, functionality, or services to downstream services. Downstream services (e.g., downstream microservices) consume data, functionality, or services from upstream services. The classification of upstream services 108 and downstream services is relative to the SUT 104. Specifically, upstream services 108 are microservices that the SUT 104 depends on, while downstream services consume the SUT 104. In response to a downstream request from a downstream service, the SUT 104 may call one or more upstream services 108 using an upstream request and receive upstream responses in return. The SUT 104 then returns a downstream response to the downstream service.

In environment 100, the upstream services 108 are controlled by the mock proxy system 106, which typically sits between the SUT 104 and upstream services 108. As described above, the proxy system 106 includes the mock proxy server 110, which runs the mock service API 112, and the mock data storage 114. The mock proxy server 110 is the server or pod on which the mock service API 112 and a mock data cache are run. The mock service API 112 represents an API or interface that routes the upstream requests and responses between the SUT 104 and upstream services 108. The mock proxy server 110 is communicatively coupled to the mock data storage 114, which stores the upstream requests and upstream responses, including snapshot files, as mock data. The mock proxy system 106 uses quality assurance (QA) parameters passed through test request headers combined with the proxy identification to determine whether to conduct a production data recording or mock data return.

This document also describes a specific data structure (e.g., a JSON contract) to compare the structures of the SUT API responses. Conventional snapshot testing methodologies often use a JSON Schema data structure to compare structures. JSON Schema is a declarative language used to annotate and validate the structure, constraints, and data types of JSON objects. JSON Schema, however, tends to be difficult to read or generate because it can become very large for many real-life projects. For each nest level of JSON, at least two levels of JSON Schema are generated.

In contrast, the test project 102 utilizes a different data structure, including a JSON data structure or JSON Contract. The JSON Contract simplifies the process to generate and compare JSON API contracts or responses. The JSON Contract categorizes the data type of each field in an adaptive JSON object, which accelerates the process of updating mock data for upstream services and test results for downstream services. The JSON Contract may be generated from JSON without any dependency or human intervention. An example adaptive JSON object follows:

```
{
  ”productId”: 1,
  ”productName”: ”An ice sculpture”,
  ”price”: 12.5,
  ”tags”: [symbol] ” cold”, ”ice” [symbol] ,
  ”dimensions”: {
    ”length”: 7.0,
    ”width”: 12.0,
    ”height”: 9.5
  },
  ”warehouseLocation”: {
    ”latitude”: −78.75,
    ”longitude”: 20.4
  }
} [symbol]
indicates data missing or illegible when filed
```

The corresponding JSON Contract for the example adaptive JSON object follows:

```
{
  ”productId”: ”number”,
  ”productName”: ”string”,
  ”price”: ”number”,
  ”tags”: [symbol] ”string” [symbol] ,
  ”dimensions”: {
    ”length”: ”number”,
    ”width”: ”number”,
    ”height”: ”number”
  },
  ”warehouseLocation”: {
    ”latitude”: ”number” ,
    ”longitude”: ”number”
  }
} [symbol]
indicates data missing or illegible when filed
```

The environment 100 also includes a computing device 116 and a service provider system 120. In one or more implementations, the computing device 116 and the service provider system 120 are communicatively coupled via network(s) 118. One example of the network(s) 118 is the Internet, although one or more of the computing device 116 or the service provider system 120 may be communicatively coupled using one or more different connections or different networks in various implementations. The SUT 104 is representative of one or more microservices provided by the service provider system 120.

The computing device 116 implements an application that supports the communication of data across the network(s) 118 between the computing device 116 and the service provider system 120. By supporting such data communication, the application provides a respective user of the computing device 116 (and users of other computing devices) access to an online marketplace 122. For example, the computing device 116 receives data from the service provider system 120. Based on the received data, the application causes various systems of the computing device 116 to output user interfaces of the online marketplace 122, such as by displaying user interfaces via display devices or making accessible voice-based user interfaces.

Through user interaction with the computing device 116, the application receives user input via one or more user interfaces of the online marketplace 122. Examples of such input include but are not limited to receiving touch input in relation to portions of a displayed user interface, receiving one or more voice commands, receiving typed input (e.g., via a physical or virtual (“soft”) keyboard), receiving mouse or stylus input, and so forth. One example of the application is a browser, which is operable to navigate to a website of the online marketplace 122, display pages of the website, and facilitate user interaction with web pages of the online marketplace 122's website. Another example of the application is a web-based computer application of the online marketplace 122, such as a mobile or desktop application. The application may be configured in different ways, which enable users to interact with their computing devices and, by extension, perform actions on the online marketplace 122.

In one or more implementations, users register with the service provider system 120 to obtain respective user accounts with the online marketplace 122. Such registration may include, for instance, providing an email address and establishing a username and password combination. Subsequent to registering with the service provider system 120, computing devices (e.g., the computing device 116) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 122 may be a guest account that does not require a user to sign in or otherwise authenticate to an already established account before interacting with the online marketplace 122.

Broadly speaking, the online marketplace 122 is configured to generate listings for items and to expose those listings (e.g., publish them) to one or more computing devices, including the computing device 116. For example, the online marketplace 122 may generate listings for items for sale and expose those listings to computing devices, such that the users of the computing devices can interact with the listings via user interfaces to initiate transactions (e.g., purchases, add to wish lists, share, and so on) in relation to the respective item or items of the listings. In accordance with the described techniques, the online marketplace 122 is configured to generate listings for one or more types of physical goods or property (e.g., clothing and/or clothing accessories, collectibles, furniture, decorative items, textiles, luxury items, electronics, real property, physical computer-readable storage having one or more video games stored thereon, and so on), services (e.g., babysitting, dog walking, house cleaning, and so on), digital items (e.g., digital images, digital music, digital videos) that can be downloaded via the network(s) 118, and blockchain-backed assets (e.g., non-fungible tokens (NFTs)), to name just a few.

In the illustrated environment 100, the online marketplace 122 includes a storage device 124, which is depicted as maintaining real-time listing data 126. The real-time listing data 126 includes listings of the online marketplace 122. The storage device 124 may represent one or more databases and/or other types of storage capable of storing the real-time listing data 126. The service provider system 120 may implement the online marketplace 122 by using servers that execute stored instructions to deploy various services of the service provider system 120.

Having considered an example of an environment, consider now a discussion of some example details of the systems and techniques for test-oriented architectural frameworks for determining application test results using adaptive objects in accordance with one or more implementations.

Data Structure Generation from Data Objects

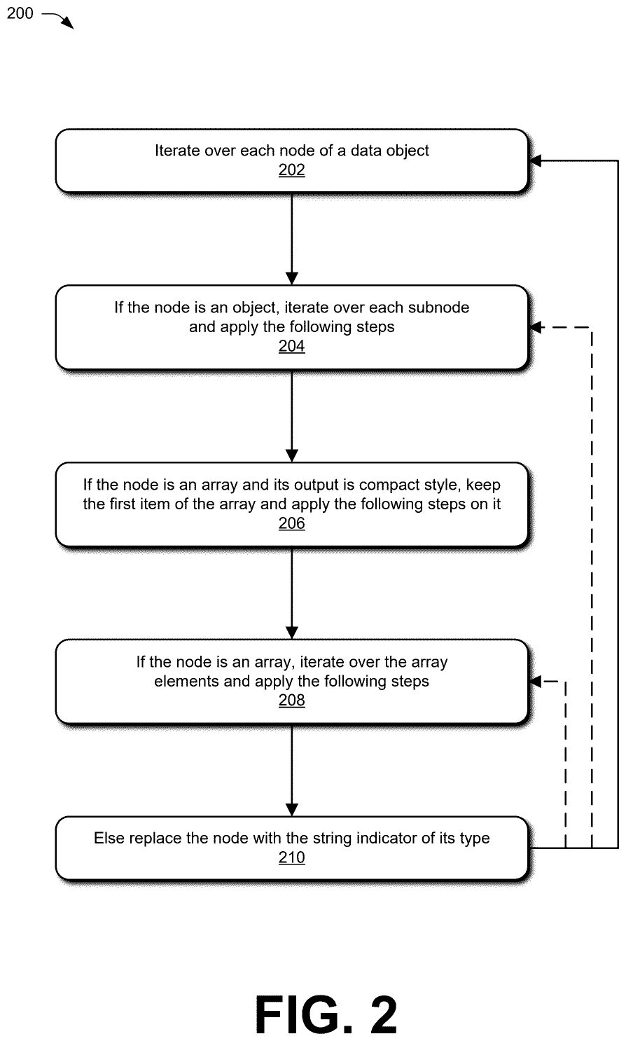

FIG. 2 depicts an example procedure 200 for converting a data object to a data structure in a test-oriented architectural framework for determining application test results using adaptive objects. Aspects of procedure 200 may be implemented in hardware, firmware, software, or a combination thereof. The procedures are shown as blocks that specify operations performed by one or more devices and are not necessarily limited to the orders shown for performing the operations by the respective blocks. In some implementations, additional or fewer operations may be performed.

Using procedure 200, a data structure (e.g., a JSON data structure or JSON Contract) is automatically generated from an object (e.g., an adaptive JSON object) by code. The data structure or JSON Structure provides an efficient, versatile, and user-friendly way to compare the structures of the SUT 104 response (e.g., a test response versus a stored result). As demonstrated by procedure 200, converting from an JSON object to JSON Contract is relatively easy and is automatable and maintains the same structure as the original JSON data. In addition, JSON Contract supports partial replacement of the original adaptive JSON data in a test response.

Because the JSON Contract is directly generated from the JSON object, the test project 102 does not need additional support information, simplifying the testing process and makes the automated testing process more reliable. needing to Following the discussion of procedure 200, an example of the code for this procedure, along with an example adaptive JSON object and JSON Contract, is provided below.

Each node of the nodes of a data object is iterated over (block 202). For example, a software routine or code iterates through each node of multiple nodes of a JSON object.

If the node is an object, each subnode is iterated and procedure 200 is applied to the subnode (block 204). For example, if a particular node is an object, the software routine iterates through each subnode of the object and applies the following blocks (e.g., blocks 206 through 210) to the subnodes.

If the node is an array and the array's output has a compact style, the first item of the array is kept, and procedure 200 is applied thereto (block 206). For example, if the node (or subnode) is an array with a compact-style output, the software routine keeps the first item of the array and proceeds with the rest of procedure 200.

If the node is an array, the array elements are iterated over, and procedure 200 is applied to each element (block 208). For example, if the node (or subnode) is an array (e.g., with or without a compact-style output), the software routine iterates through each element and proceeds with the rest of procedure 200.

The node, subnode, or element is replaced with a string indicator of its type (block 210). For example, the software routine replaces the nodes, which may include subnodes and array elements, with a string indicator of the node's type. Depending on the node type, the software routine returns to block 202, 204, or 208 until each node has been processed.

An example JSON object follows:

```
{
”priceGuidance”: {
  ”suggestedPrice”: {
    ”original”: {
      ”currency”: ”USD”,
      ”amount”: ”130.00”,
      ”auction”: ” [symbol] 0.00”
    },
    ”converted”: {
      ”currency”: ”CAD”,
      ”amount”: ”175.50”,
      ”auction”: ”81.00”
    }
  } [symbol]
,
”metricsTrends”: {
  ”charts”: [symbol]
    {
      ”title”: ”Median sold price”,
      ”series”: [symbol] ”averageSold” [symbol] [symbol]
    ,

[symbol]

      ”title”: ”Total sold”,
      ”series”: [symbol] ”quantity”, ”quantityRegressionLine” [symbol]
    } [symbol]
  ,
  ”granularity”: ”DAY”,
  ”series”: [symbol]
    {
      ”id”: ”averageSold”,
      ”label”: ”Median sold price”,
      ”seriesType”: ”line”,
      ”data”: [symbol] [symbol]
        1686207600000, 0.0 [symbol] , [symbol]
        1686294000000, 0.0

[symbol]

[symbol]

[symbol]

      ,

[symbol]

        ”id”: ”quantity”,
        ”label”: ”Total sold”,
        ”seriesType”: ”column”,
        ”data”: [symbol] [symbol]
          1686207600000, 0.0 [symbol] , [symbol]
          1686294000000, 0.0

[symbol]

[symbol]

[symbol]

      ,

[symbol]

      ”id”: ”quantityRegressionLine”,
      ”label”: ”Trend line”,
      ”seriesType”: ”line”,
        ”data”: [symbol] [symbol]
          1680207000000, 0.2929810320114 [symbol] , [symbol]
          169398 [symbol] 600000, 0.476349737219301

[symbol]

[symbol]

[symbol]

[symbol]


    ,
    ”meta”: {
      ”name”: ”metricsTrends”
    }
  }
} [symbol]
indicates data missing or illegible when filed
```

An example JSON Contract generated from the example JSON object using procedure 200 follows:

```
{
  ”priceGuidance”: {
    ”suggestedPrice”: {
      ”original”: {
        ”currency”: ”string”,
        ”amount”: ”string”,
        ”auction”: ”string”
      },
      ”converted”: {
        ”currency”: ”string”,
        ”amount”: ”string”,
        ”auction”: ”string”

[symbol]

[symbol]

[symbol]


  ,
  ”metricsTrends”: {
    ”charts”: [symbol]
      { ”title”: ”string”, ”series”: [symbol] ”string” [symbol] },
      { ”title”: ”string”, ”series”: [symbol] ”string”, ”string” [symbol] [symbol] [symbol]
    ,
    ”granularity”: ”string”,
    ”series”: [symbol]
      {
        ”id”: ”string”,
        ”label”: ”string”,
        ”seriesType”: ”string”,
        ”data”: [symbol] [symbol]
          ”number”, ”number” [symbol] , [symbol]
          ”number”, ”number”

[symbol]

[symbol]

      },
      {
        ”id”: ”string”,
        ”label”: ”string”,
        ”seriesType”: ”string”,
        ”data”: [symbol] [symbol]
          ”number”, ”number” [symbol] , [symbol]
          ”number”, ”number”

[symbol]

[symbol]

      },
      {
        ”id”: ”string”,
        ”label”: ”string”,
        ”seriesType”: ”string”,
        ”date”: [symbol] [symbol]
          ”number”, ”number” [symbol] , [symbol]
          ”number”, ”number”

[symbol]

[symbol]

[symbol]

[symbol]


    ,
    ”meta”: { ”name”: ”string” }

[symbol]

[symbol]

[symbol]


indicates data missing or illegible when filed
```

In some implementations of procedure 200, a compact data structure (e.g., a Compact JSON Contract) is generated to reduce or collapse array fields into shorter entries by keeping the first item of the array. An example Compact JSON Contract generated from the example JSON object using procedure 200 follows:

```
{
  ”priceGuidance”: {
    ”suggestedPrice”: [symbol]
      ”original”: {
        ”currency”: ”string”,
        ”amount”: ”string”,
        ”auction”: ”string”
      },
      ”converted”: {
        ”currency”: ”string”,
        ”amount”: ”string”,
        ”auction”: ”string”
      }

[symbol]

[symbol]

  ,
  ”metricsTrends”: {
    ”charts”: [symbol] { ”title”: ”string”, ”series”: [symbol] ”string” [symbol] } [symbol] ,
    ”granularity”: ”string”,
    ”series”: [symbol]
      {
        ”id”: ”string”,
        ”label”: ”string”,
        ”seriesType”: ”string”,
        ”data”: [symbol] [symbol] ”number” [symbol] [symbol]
      }, [symbol]
    ,
    ”meta”: { ”name”: ”string” }

[symbol]

[symbol]

[symbol]


indicates data missing or illegible when filed
```

In some implementations, the test project 102 compares only a portion of the JSON Response from the SUT API. The partial comparison is possible because JSON Contract is compatible with the original JSON data in a test response. To specify a portion of the JSON Response for analysis, a JSON Path instruction is provided in the test input file. The test project 102 then only saves and compares the object nodes (e.g., JSON nodes) that match those in the JSON Path instruction.

To simplify the complex testing requirements inherent in many test projects 102, a JSON Converter processes and converts the JSON object and JSON Contract data to generate an adaptive JSON. The adaptive JSON can include just JSON data, just JSON Contract, or JSON Contract mixed with JSON data. A converter field (e.g., resConverter or resCompact) is added in each test project 102 under the test input folder to implement the JSON Converter and JSON Contract. The converter field indicates the formation of the downstream response snapshot. The JSON Converter generally includes two children: the main filter object and the structure filter object. The main filter object generally includes two children: an inclusive filter list and an exclusive filter list. Similarly, the structure filter object includes two children: convert filter list and keep filter list. These four lists are included as lists in the JSON Path file.

The basic logic in applying a JSON Converter to a JSON data object is to convert the JSON data to JSON Contract data based on the structure filter object. The procedure for applying the structure filter object to JSON object data is to find all the valid convert paths based on the convert filters; for each of the valid convert paths, find each Keep JSON Objects based on the valid keep filters belonging to the convert path; convert the JSON data to JSON Contract data based on the list of valid convert path; and restore the JSON data from the Keep JSON Objects. If only the structure filter object is provided, the JSON Converter is applied to the entirety of the JSON data.

The new JSON Contract data is retrieved based on the main filter object. The procedure for applying the main filters object to JSON data includes removing the data matched by the exclusive filters and creating the new JSON Contract data based on the inclusive filters. The result is filtered JSON data if only the main filter object is provided in the JSON Converter file.

By combining four types of filters together, the JSON Converter provides a flexible and efficient procedure for processing and filtering JSON data. An example of applying the JSON Converter with main and structure filter objects to sample JSON data follows:

```
{
  ”main”: {
    ”inclusive”: [
      ”$.priceGuidance”,
      ”$.metricsTrends.charts[*].series”,
      ”$.|metricsTrends.granularity”,
      ”$.metricsTrends.series”,
    ],
    ”exclusive”: [”$.metricsTrends.series[*].id”]
  },
  ”structure”: {
    ”convert”: [”$.metricsTrends.series[*].data”, ”$.
        priceGuidance”],
    ”keep”: [”$.priceGuidance..currency”]
  }
}
```

Compact ADJSON Result:

```
  {
    ”priceGuidance”: {
      ”suggestedPrice”: {
        ”original”: {
          ”currency”: ”USD”,
          ”amount”: ”string”,
          ”auction”: ”string”
        },
        ”converted”: {
          ”currency”: ”CAD”
          ”amount”: ”string”,
          ”auction”: ”string”
        }
      }
    },
  ”metricsTrends”: {
    ”charts”: [
      { ”series”: [”averageSold”] },
      { ”series”: [”quantity”, ”quantityRegressionLine”] }
    ],
    ”granularity”: ”DAY”,
    ”series”: [
      {
        ”label”: ”Median sold price”,
        ”seriesType”: ”line”,
        ”data”: [[”number”]]
      },
      { ”label”: ”Total sold”, ”seriesType”: ”column”, ”data”:
          [[”number”]] },
      { ”label”: ”Trend line”, ”seriesType”: ”line”, ”data”: [[”
          number”]] }
    ]
  }
}
```

Fall ADJSON Result:

```
{
  ”priceGuidance”: {
    ”suggestedPrice”: {
      ”original”: {
        ”currency”: ”USD”,
        ”amount”: ”string”,
        ”auction”: ”string”
      },
      ”converted”: {
        ”currency”: ”CAD”,
        ”amount”: ”string”,
        ”auction”: ”string”
      }
    }
  },
  ”metricsTrends”: {
    ”charts”: [
      { ”series”: [”averageSold”] },
      { ”series”: [”quantity”, ”quantityRegressionLine”] }
    ],
    ”granularity”: ”DAY”,
    ”series”: [
      {
        ”label”: ”Median sold price”,
        ”seriesType”: ”line”,
        ”data”: [
          [” number” , ”number”],
          [” number” , ”number”]
        ]
      },
      {
        ”label”: ”Total sold”,
        ”seriesType”: ”column”,
        ”data”: [
          [” number” , ”number”],
          [” number” , ”number”]
        ]
      },
      {
        ”label”: ”Trend line”,
        ”seriesType”: ”line”,
        ”data”: [
          [”number”, ”number”],
          [”number”, ”number”]
        ]
      }
    ]
  }
}
```

When only the main filter objects are used, the resultant data is pure JSON data. The combination of the inclusive and exclusive filters provides a flexible and easy procedure to obtain expected JSON results by filtering out data not of interest in the test project 102.

Having discussed exemplary details of data structure (e.g., JSON Contract) generation from data objects (e.g., JSON data objects), consider now some examples of procedures and scenarios to illustrate additional aspects of the techniques.

### Example Snapshot Testing Cases

In some implementations, the test project 102 helps detect changes at the SUT 104 by using upstream mock data. Initially, the test project 102 is set up to receive downstream service requests, and then upstream mock data is recorded as downstream snapshot base files. Test project 102 can then run snapshot testing in the CI/CD pipeline or in the local environment. In this test run mode, test project 102 compares the JSON snapshot base files with the JSON responses from the SUT 104, which uses the recorded mock data instead of responses from the upstream services. Using a mock server solution, the SUT 104 is isolated from changes to upstream services to focus the test project 102 on finding regressions caused by changes to the SUT 104.

Using snapshot testing for upstream services allows the test project 102 to detect changes to the upstream services contract. For example, it is common that legacy systems are maintained without current engineers having a deep understanding of their code base. It is also common that upgrades are only needed for dependency libraries. In such situations, issues arise from the security upgrade due to structure changes, but not how the data was calculated. In these situations, snapshot testing without upstream service mock data is used.

In other implementations, traffic mirroring is used to copy inbound traffic and send it to an alternate destination. Traffic mirroring allows production traffic to be copied and sent to the SUT 104 and then snapshot testing is used to compare the JSON responses. The JSON Contract and JSON Converter described above are used in at least one implementation to compare the test response in a traffic mirroring scenario.

Snapshot test classes are very similar and generally only differ in the testPath and testFilename. Engineers verify that the testPath is pointing to the correct folder that contains the test input files for a particular group of tests. The JSON Snapshot test cases are generally stored under the input folder at the Project root folder. By using the testPath defined in the Test Class, the JSON files under this test path are parsed, and the requests are sent to the SUT 104. If the test filename is also provided, then only the JSON file with the same name is used.

In one implementation of test input files, the endpoint path and the request method are set at the top level of the JSON file. More detailed information about the test cases is defined in the tests section. Each test generally defines the request body, request parameters, and required request headers. Requests IDs used to identify the test cases are generated automatically and saved in the requestIDs field. The required request headers can exist in the top level of the JSON file or in each test case, with test-case level request headers overwriting top-level request headers. To keep test input files simple, in one implementation the test input files are written with scripts to maintain compatibility with the Postman collection format.

JSON downstream snapshot files are stored under the downstream folder at the project root folder. These files are generally stored in the subfolder named by truncating the VID UUID to its first eight characters, inside of which is a base folder to store the baseline snapshot files. When running snapshot testing, the service response data is compared with the baseline snapshot response data (e.g., resData).

In such tests, the upstream request and response snapshot are saved as mock data in mock data storage. For upstream service contract comparison and maintenance, the basic mock data structure is downloaded and saved as an upstream snapshot in the test project 102 under the upstream folder. In this way, the upstream snapshot is under version control and is easily compared.

### Service Contracts and Mock Proxy System

A key aspect of microservices is the communication and maintenance of service contracts. Service contracts are generally the inputs and outputs provided by an API. If a queuing message-consuming service is being implemented, the service contracts are the format of the message(s) in the queue.

In the described test-oriented architectural framework, service contracts include inputs of an endpoint request or resource path, request headers, and request bodies. The outputs include a response status code, response headers, and a response body. The described test-oriented architectural framework for determining application test results using adaptive objects provides solutions to store, compare, and verify upstream requests, downstream requests, and response data.

Upstream request parameter changes, upstream response data changes, or downstream response data changes can cause failures in test project 102. Upstream response data changes may relate to upstream service changes, while upstream request parameter or downstream response data changes may relate to code changes to the upstream service or the SUT 104. To focus the test project 102 on the SUT 104, mock data replaces the upstream service response and prevents the test project 102 from detecting upstream service contract changes. Instead of manually creating the mock data, the described test-oriented architectural framework uses the mock proxy system 106 to retrieve and save the upstream service response as mock data. The mock proxy system 106 is designed in at least one implementation to retrieve, process, and save upstream service responses. The mock proxy system 106 allows a service contract to be recorded and verified by test cases with their corresponding upstream and downstream snapshot collections or files. In other implementations, mock data is manually created and updated.

The mock proxy system 106 usually sits between the SUT 104 and the upstream services 108. A proxyID may be used for each upstream service 108 to control how the upstream requests and responses are handled. The mock proxy system 106 generally records upstream requests and responses from staging or production and saves them as contract snapshots, also called mock data. The downstream response data can be generated based on the recorded mock data.

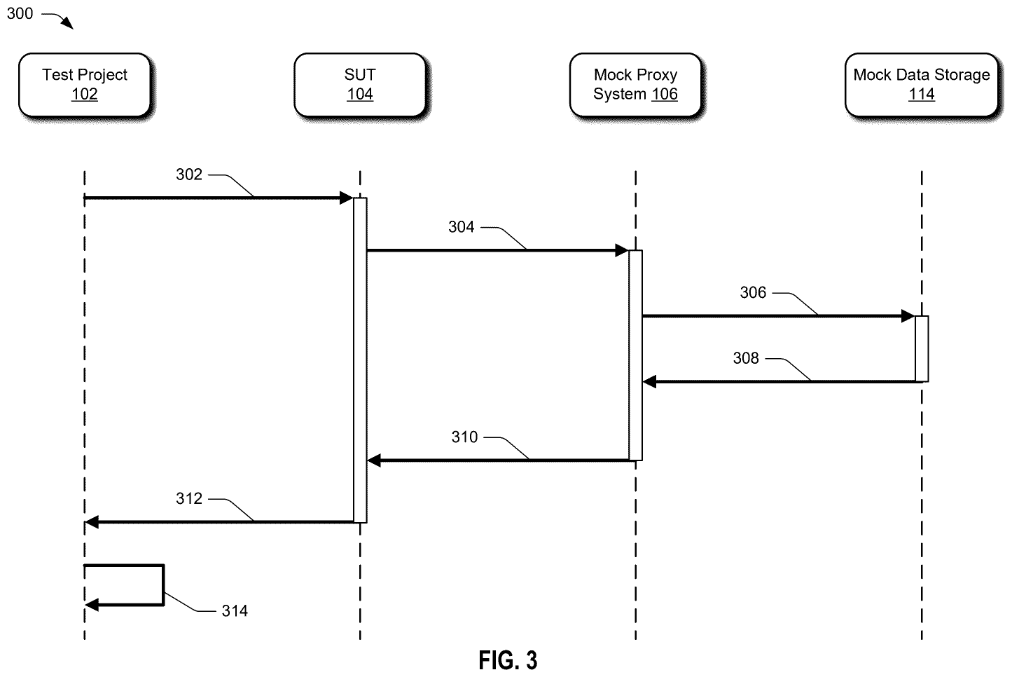

FIG. 3 illustrates an example procedure 300 for a cache flow of the mock proxy system 106. The mock proxy system 106 provides solutions to create mock data by recording QA response data or production response data based on the request flow action settings, which are controlled by using scope ID, request ID, and proxy ID.

In procedure 300, the test project 102 sends downstream test requests to the SUT 104 (operation 302), which in turn sends upstream requests to the mock proxy system 106 (operation 304). The mock proxy system 106 sends matched upstream requests to the mock data storage 114 (operation 306). The mock data storage 114 includes upstream service contracts or responses as mock data. The mock data storage 114 returns the upstream responses (e.g., stored as mock data) to the mock proxy system 106 (operation 308), which returns upstream responses to the SUT 104 (operation 310). The SUT 104 returns downstream test responses to the test project 102 (operation 312). The test project 102 finally compares the test responses with JSON snapshot baseline files (operation 314).

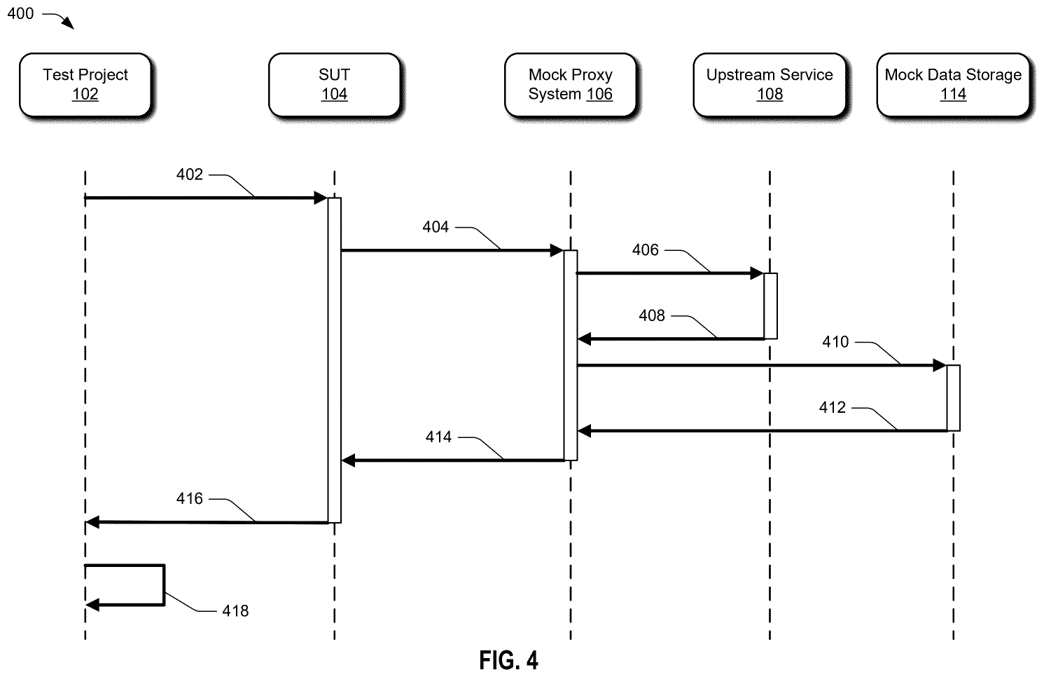

FIG. 4 illustrates an example procedure 400 for a mock proxy system 106 recording flow. In particular, the mock proxy system 106 calls the upstream service 108 and saves the response as mock data. In particular, the test project 102 sends downstream test requests to the SUT 104 (operation 402), which sends upstream requests to the mock proxy system 106 (e.g., the mock proxy server 110) (operation 404). The mock proxy system 106 sends upstream requests to the upstream service 108 (operation 406), which returns upstream responses (operation 408). The mock proxy system 106 then saves the upstream request and response information to the mock data storage 114 as mock data (operation 410).

The mock data storage 114 indicates it has completed the save operation (operation 412). The mock proxy system 106 returns upstream responses to the SUT 104 (operation 414). The SUT 104 returns downstream test responses to the test project 102 (operation 416). The test project 102 saves the JSON snapshot baseline files (operation 418) in test future changes to the SUT 104.

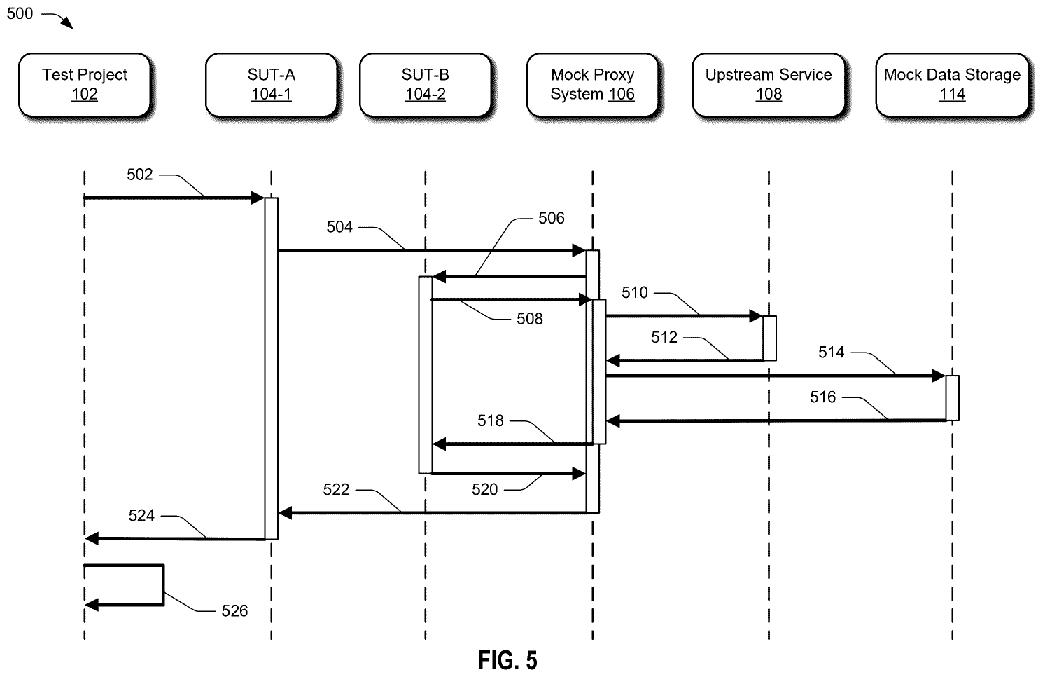

FIG. 5 illustrates an example procedure 500 for a forwarding and recording flow of the mock proxy system 106. In particular, the mock proxy flow is verified in a sidecar design style. The mock proxy system 106 forwards a service request for a first SUT (SUT-A) 112-1 and records another service request for a second SUT (SUT-B) 112-2.

The test project 102 sends downstream test requests to the SUT-A 104-1 (operation 502), which sends service requests to the mock proxy system 106 (operation 504). The mock proxy system 106 forwards the service requests to the SUT-B 104-2 (operation 506), which sends upstream requests to the mock proxy system 106 (operation 508). The mock proxy system 106 sends the upstream requests to the upstream service 108 (operation 510), which returns upstream responses (operation 512). The mock proxy system 106 then saves the upstream request and response information to the mock data storage 114 (operation 514). The mock data storage 114 indicates it has completed the save operation (operation 516).

The mock proxy system 106 returns the upstream responses to the SUT-B 104-2 (operation 518), which returns the service requests to the mock proxy system 106 (operation 520). The mock proxy system 106 returns the service requests to the SUT-A 104-1 (operation 522), which returns downstream test responses to the test project 102 (operation 524). The test project 102 saves the JSON snapshot baseline files (operation 526).

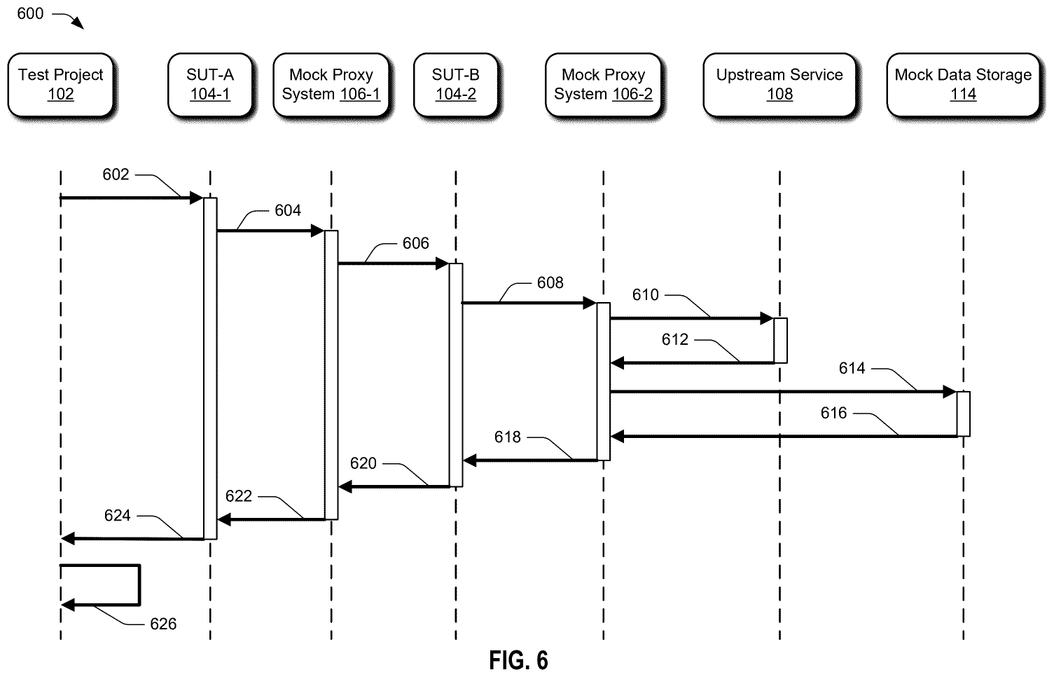

FIG. 6 illustrates an example procedure 600 for verifying an upstream and downstream contract. The mock proxy flow in procedure 600 provides a multi-aspect control flow.

In particular, test project 102 sends downstream test requests to the SUT-A 104-1 (operation 602), which sends service requests to a first mock proxy system 106-1 (operation 604). The first mock proxy system 106-1 forwards the service requests to the SUT-B 104-2 (operation 606), which sends upstream requests to a second mock proxy system 106-2 (operation 608). The second mock proxy system 106-2 sends the upstream requests to the upstream service 108 (operation 610), which returns upstream responses to the second mock proxy system 106-2 (operation 612).

The second mock proxy system 106-2 then saves the upstream request and response information to the mock data storage 114 (operation 614). The mock data storage 114 indicates it has completed the save operation to the second mock proxy system 106-2 (operation 616).

The second mock proxy system 106-2 returns the upstream responses to the SUT-B 104-2 (operation 618), which returns the service requests to the first mock proxy system 106-1 (operation 620). The first mock proxy system 106-1 returns the service requests to the SUT-A 104-1 (operation 622), which returns downstream test responses to the test project 102 (operation 624). The test project 102 saves the JSON snapshot baseline files (operation 626).

In the described test-oriented architectural framework, the proxyID and VID control the test requests flow. A specific header sends the VID from test project 102 to SUT 104. Then the SUT 104 transparently passes the header to the mock proxy system 106 along with the proxyID, which is captured from the request URL pointing to the mock proxy system 106. By changing action mapping settings based on proxyID and VID, the test project 102 runs a test against one or multiple microservices as the SUT 104. In addition, scope ID, request ID, test run ID, and proxyID are used to categorize upstream requests, mock data, and downstream snapshots, which can be used to debug and track the requests and responses with test run logs.

There are several strategies available to implement and integrate the mock proxy with a SUT within a test-oriented architectural framework, including a service approach, library approach, and sidecar design pattern.

In the service approach, using a request-response mechanism, the SUT 104 makes network calls to invoke the mock proxy services. The code for services and main application logic is executed in different pods or server instances. The SUT 104 and services are deployed separately so that resources are not shared, meaning that resources can be optimized independently for both application and service. The SUT 104 can be released independently to address bug fixes, but version upgrades are unnecessary. On the other hand, the SUT 104 has relatively less ease of use than the library approach. In addition, the latency is significantly higher as the application and service are distributed and a network call is required for invocation.

The library approach is widely used, where the reusable code is developed and released as a library. The SUT 104 defines a library as a direct dependency, uses the provided APIs, and ships its code along with the main application logic. The library and main application logic code are executed as part of the same process. The code in the library is executed in the same process as that of the SUT 104, so there is no network latency. The overall availability is also high as there is no network partition. In addition, this approach is very simple to use, and the environment context (e.g., memory, processor) is accessible to the library because they are part of the same container. In contrast, resources are shared with the main application, meaning that the library's performance can have side effects on the main application. The library is the same as the main application, leading to multiple implementations required for each language. In addition, any bug fixes in the library require code changes and testing across all the client applications.

The sidecar pattern approach is a single-node pattern made up of two containers. The first container is the application container that contains the core logic for the SUT 104. Without this container, the SUT 104 does not exist. The second container is a sidecar container that augments and improves the application container, often without the application container's knowledge. In its simplest form, a sidecar container can add functionality to a container that might otherwise be difficult to improve. The sidecar approach can be released independently to address bug fixes. It can also be developed using any technology that fits its purpose. The latency is also lower than approaches that use services, but higher than those that use libraries. The availability is also better than the other approaches because there is no real network partition.

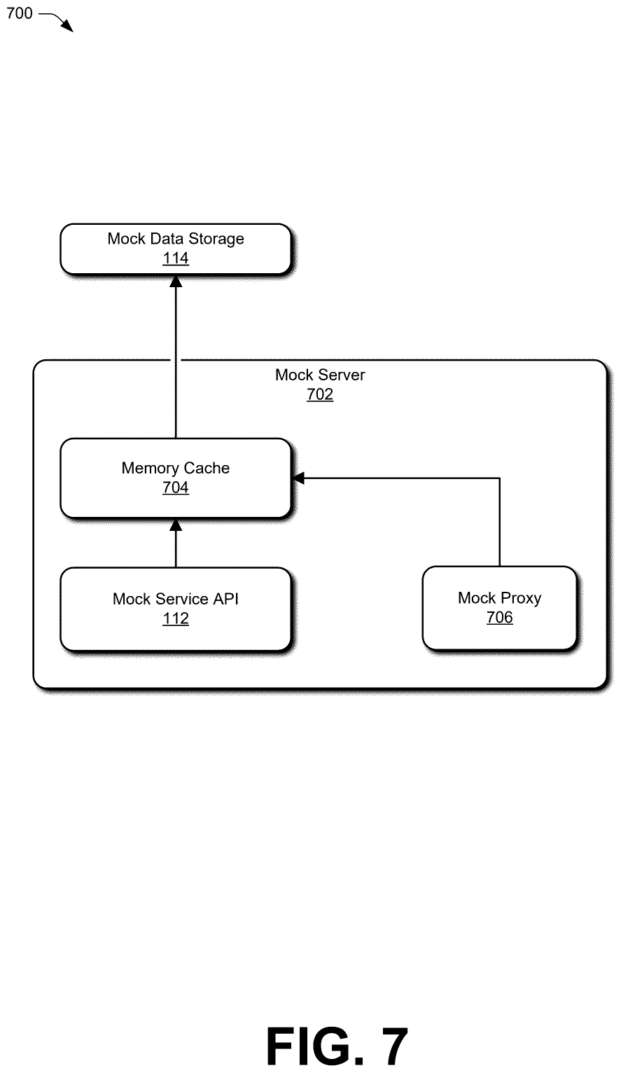

FIG. 7 illustrates an example implementation 700 of a mock server 702 used in a test-oriented architectural framework for determining application test results using adaptive objects. The mock server 702 includes a memory cache 704, the mock service API 112, and a mock proxy 706. The memory cache 704 syncs data to mock data storage 114, which may be implemented as cloud storage. One advantage of using a mock proxy system is that active mock data for a specific application or service is not large and easily fits in memory, which means cloud storage (e.g., mock data storage 114) is available. In the illustrated implementation 700, the mock proxy 706 queries data from the memory cache 704 and/or the mock data storage 114. Similarly, the mock service API 112 saves and retrieves data in the mock data storage 114 via the memory cache 704.

In one implementation, the mock service API 112 and mock proxy 706 use a NodeJS-based service to accept HTTP requests and proxy requests, process JSON data, and communicate with private data storage. Handling JSON without a predefined data structure is generally easier in JavaScript than in Java or other languages. In addition, the use of JSON allows a high-performance testing framework at a relatively low cost.

To satisfy data protection requirements, the test project 102 includes filters to mask production data with a data sanitization algorithm. Because the mock proxy system is designed based on the NodeJS low-level HTTP modules, the benefits of native JSON support from JavaScript are leveraged.

### Example Procedure

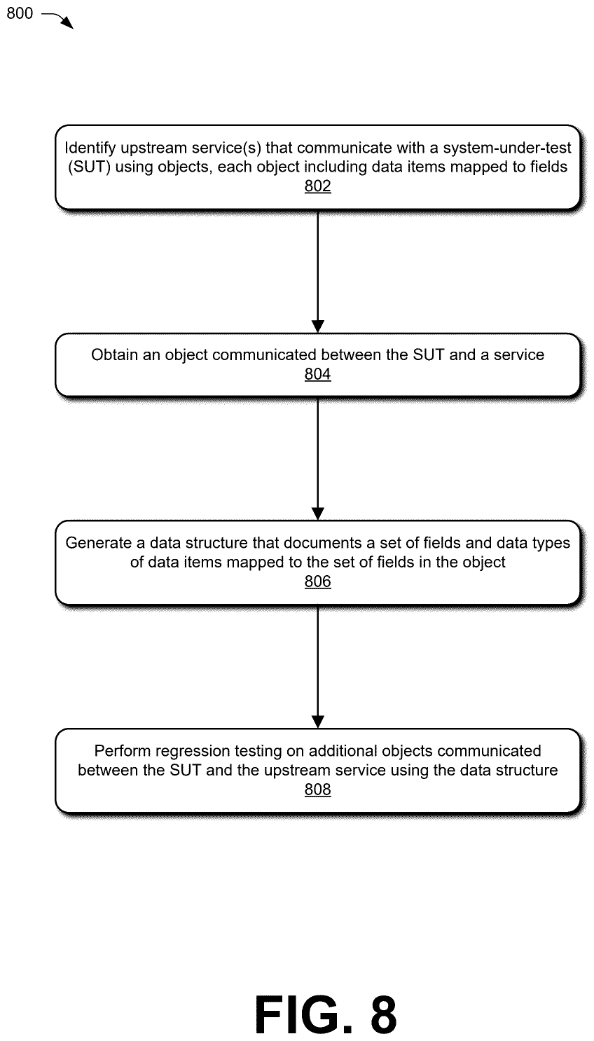

FIG. 8 illustrates an example procedure 800 to implement a test-oriented architectural framework for determining application test results using adaptive objects. Aspects of procedure 800 may be implemented in hardware, firmware, software, or a combination thereof. Procedure 800 is illustrated as a set of blocks that specify operations performed by one or more devices and are not necessarily limited to the orders shown for performing the operations by the respective blocks.

At a test framework associated with the SUT, one or more upstream services that communicate with an SUT using a plurality of objects are identified (block 802). Each object of the plurality of objects includes one or more fields and one or more data items corresponding to one or more fields. For example, test project 102 identifies upstream services 108 that communicate with the SUT 104. The upstream services 108 communicate with the SUT 104 using data objects, which include data items mapped to one or more fields.

An object communicated between the SUT and a particular upstream service of the one or more upstream services is obtained (block 804). For example, test project 102 obtains a data object (e.g., an adaptive JSON object) communicated between the SUT 104 and a particular upstream service 108.

Based on the object, a data structure that documents a set of fields and data types of data items mapped to the set of fields in the object is generated (block 806). For example, test project 102 then generates a data structure (e.g., a JSON Contract) for the data object that details the set of fields and the data item type for data items mapped to those fields. The data structure is saved as a snapshot file for later testing of updates or changes to the SUT 104. An example procedure for generating the data structure from the data object is described in reference to FIG. 2.

Using the data structure, additional objects communicated between the SUT and the particular upstream service are regression tested (block 808). For example, test project 102 performs automatic snapshot or regression testing on any changes or updates to the SUT 104 using the saved data structure compared to a newly generated data structure in subsequent communications with the particular upstream service 108.

### Example System and Device

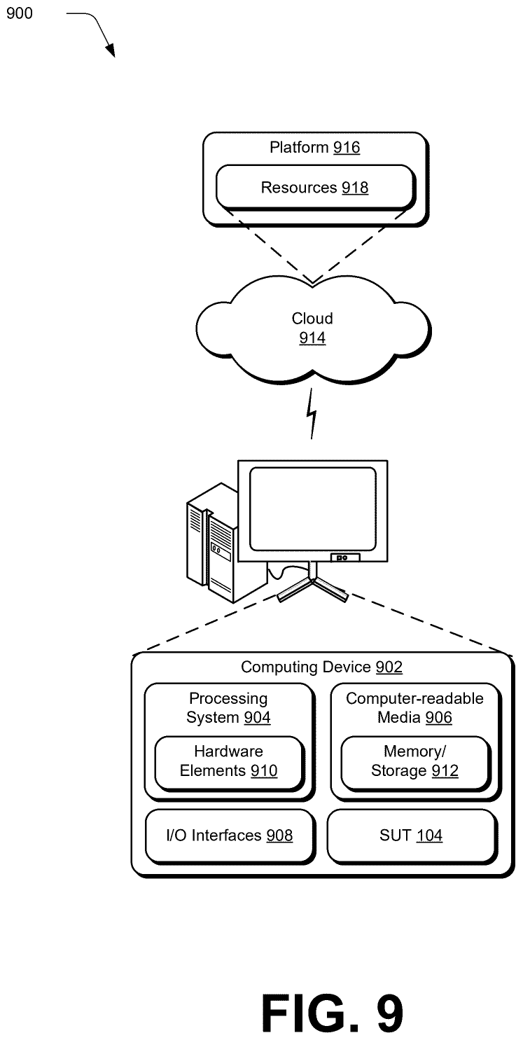

FIG. 9 illustrates an example of a system 900 that includes an example computing device that is representative of one or more computing systems and/or devices that may implement services tested using a test-oriented architectural framework for determining application test results using adaptive objects and the various techniques described herein. This is illustrated through the inclusion of the SUT 104. The computing device 902 may be, for example, a service provider server, a device associated with a client (e.g., a client device), an on-chip system, and/or any other suitable computing device or computing system.

The example computing device 902, as illustrated, includes a processing system 904, one or more computer-readable media 906, and one or more I/O interfaces 908 that are communicatively coupled, one to another. Although not shown, the computing device 902 may further include a system bus or other data and command transfer system that couples the various components from one to another. A system bus can include any one or combination of different bus structures, such as a memory bus or memory controller, a peripheral bus, a universal serial bus, and/or a processor or local bus that utilizes various bus architectures. A variety of other examples are also contemplated, such as control and data lines.

The processing system 904 is representative of the functionality to perform one or more operations using hardware. Accordingly, the processing system 904 is illustrated as including hardware elements 910 that may be configured as processors, functional blocks, and so forth. This may include implementation in hardware as an application-specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read-only memory (ROM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways, as further described below.

Input/output interface(s) 908 are representative of functionality to allow a user to enter commands and information to computing device 902 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways, as further described below, to support user interaction.

Various techniques may be described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal-bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium configured to transmit instructions to the hardware of the computing device 902, such as via a network. Signal media typically may embody computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module executable by the computing device 902 as software may be achieved at least partially in hardware, e.g., through the use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through a distributed system, such as over a “cloud” 914 via a platform 916 as described below.

Cloud 914 includes and/or is representative of platform 916 for resources 918. Platform 916 abstracts the underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

Platform 916 may abstract resources and functions to connect computing device 902 with other computing devices. The platform 916 may also abstract scaling of resources to provide a corresponding level of scale to encountered demand for the resources 918 implemented via the platform 916. Accordingly, the implementation of functionality described herein may be distributed throughout the system 900 in an interconnected device embodiment. For example, the functionality may be implemented in part on the computing device 902 as well as via platform 916, which abstracts the functionality of cloud 914.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method for generating data structures for data communications associated with a system-under-test (SUT), the method comprising:
identifying, at a test framework associated with the SUT, one or more upstream services configured to communicate with the SUT using a plurality of objects, wherein each object of the plurality of objects includes one or more fields and one or more data items corresponding to the one or more fields;
obtaining an object communicated between the SUT and an upstream service of the one or more upstream services;
generating, based on the object, a data structure that documents a set of fields and data types of data items mapped to the set of fields in the object; and
performing regression testing, using the data structure, on additional objects communicated between the SUT and the upstream service.

2. The method of claim 1, wherein the plurality of objects and the object are JavaScript Object Notation (JSON) objects and the data structure is configured to have a JSON format.

3. The method of claim 2, wherein the data structure with the JSON format is automatically generated from the JSON object communicated between the SUT and the upstream service associated with the SUT.

4. The method of claim 2, wherein generating the data structure based on the object comprises:
iterating over each node of the object;
in response to the node being an object, iterating over each subnode of the node;
in response to the node or the subnode being an array without a compact-style output, iterating over each array element of the array; and
replacing the node, the subnode, or the array element with a string indicator of its type.

5. The method of claim 2, wherein generating the data structure based on the object further comprises generating a partial data structure having the JSON format and a subset of the set of fields.

6. The method of claim 1, wherein the data structure is generated for the set of fields that match instructions in a converter object.

7. The method of claim 6, wherein the converter object includes:
a main filter object that includes an inclusive filter list and an exclusive filter list; and
a structure filter object that includes a convert filter list and a keep filter list.

8. The method of claim 7, wherein applying the converter object to the object comprises:
converting the object to the data structure using the structure filter object; and
retrieving data in the data structure using the main filter object.

9. The method of claim 8, wherein applying the structure filter object to the object comprises:
finding each valid convert path of one or more valid convert paths using the convert filter list;
for each valid convert path, finding each keep object of one or more keep objects based on the keep filter list;
converting the data items to structure data based on the one or more valid convert paths; and
restoring the structure data from the one or more keep objects.

10. The method of claim 9, wherein applying the main filter object comprises:
removing the structure data that matches exclusive filters in the exclusive filter list; and
creating the structure data based on inclusive filters in the inclusive filter list.

11. A system comprising one or more processors associated with a test framework, the one or more processors configured to:
identify one or more upstream services configured to communicate with a system-under-test (SUT) using a plurality of objects, wherein each object of the plurality of objects includes one or more fields and one or more data items corresponding to the one or more fields;
obtain an object communicated between the SUT and an upstream service of the one or more upstream services;
generate, based on the object, a data structure that documents a set of fields and data types of data items mapped to the set of fields in the object; and
perform regression testing, using the data structure, on additional objects communicated between the SUT and the upstream service.

12. The system of claim 11, wherein the additional objects are generated based on mock data stored by a mock proxy system, the mock data being a saved upstream response of the upstream service to an upstream request.

13. The system of claim 12, wherein the mock data is stored in cloud storage.

14. The system of claim 12, wherein the mock proxy system determines whether to save an upstream response based on parameters passed in test request headers and an identification associated with the SUT.

15. The system of claim 12, wherein the system includes another SUT configured to:
receive a service request from the SUT via the mock proxy system;
send the upstream request to the mock proxy system;
receive the upstream response as the mock data from the mock proxy system; and
send a return service request to the SUT via the mock proxy system, the return service request including the additional objects.

16. The system of claim 12, wherein the system includes another SUT configured to:
receive a service request from the SUT via a first mock proxy system;
send the upstream request to a second mock proxy system;
receive the upstream response as the mock data from the second mock proxy system; and
send a return service request to the SUT via the first mock proxy system, the return service request including the additional objects.

17. The system of claim 11, wherein:
the plurality of objects and the object are JavaScript Object Notation (JSON) objects and the data structure is configured to have a JSON format; and
the data structure with the JSON format is automatically generated from the JSON object communicated between the SUT and the upstream service associated with the SUT.

18. The system of claim 17, wherein the one or more processors are further configured to generate the data structure based on the object by:
iterating over each node of the object;
in response to the node being an object, iterating over each subnode of the node;
in response to the node or the subnode being an array with a compact-style output, keeping a first item of the array;
in response to the node or the subnode being an array without the compact-style output, iterating over each array element of the array; and
replacing the node, the subnode, or the array element with a string indicator of its type.

19. One or more computer-readable storage media comprising computer-executable instructions stored thereon that, responsive to execution by one or more processors, perform operations comprising:
identifying one or more services configured to communicate with a system-under-test (SUT) using a plurality of objects, wherein each object of the plurality of objects includes one or more fields and one or more data items corresponding to the one or more fields;
obtaining an object communicated between the SUT and a service of the one or more services;
generating, based on the object, a data structure that documents a set of fields and data types of data items mapped to the set of fields in the object; and
automatically perform regression testing, using the data structure, on additional objects communicated between the SUT and the service.

20. The one or more computer-readable storage media of claim 19, wherein:
the plurality of objects and the object are JavaScript Object Notation (JSON) objects and the data structure is configured to have a JSON format; and
the data structure with the JSON format is automatically generated from the JSON object communicated between the SUT and the service associated with the SUT.
